(19) United States
(12) Patent Application Publication
(10) Pub. No.: US 2025/0328851 A1
(43) Pub. Date: Oct. 23, 2025

(54) SYSTEM AND METHODS FOR PROVIDING REAL-TIME DYNAMIC INTERFACE FOR SUPERVISING INDIVIDUALS

(71) Applicants: David Rennyson, Centreville, VA (US); James Rennyson, Centreville, VA (US); Gayetri Bhattacharjee, Aldie, VA (US); Oliver Zapanta, San Lorenzo, CA (US); Michael Davies, Redditch (GB); Pawel Krawczyk, Warsaw (PL); Piyush Patel, South Riding, VA (US); Suresh Parishi, Charlotte, NC (US); Vivek Patel, Chantilly, VA (US); Anya Priyal, Aldie, VA (US); Amitkumar Pandya, Pleasanton, CA (US)

(72) Inventors: David Rennyson, Centreville, VA (US); James Rennyson, Centreville, VA (US); Gayetri Bhattacharjee, Aldie, VA (US); Oliver Zapanta, San Lorenzo, CA (US); Michael Davies, Redditch (GB); Pawel Krawczyk, Warsaw (PL); Piyush Patel, South Riding, VA (US); Suresh Parishi, Charlotte, NC (US); Vivek Patel, Chantilly, VA (US); Anya Priyal, Aldie, VA (US); Amitkumar Pandya, Pleasanton, CA (US)

(73) Assignee: SuccessKPI, Inc., Centreville, VA (US)

(21) Appl. No.: 18/642,040

(22) Filed: Apr. 22, 2024

(51) Int. Cl. G06Q 10/0639; G06F 9/451; G10L 15/22; G10L 15/30; H04M 3/22; H04M 3/51

(52) U.S. Cl. CPC G06Q 10/06398; G06F 9/451; G10L 15/22; G10L 15/30; H04M 3/2218; H04M 3/5175; H04M 3/5183; H04M 2201/38; H04M 2201/40; H04M 2203/402

(57) ABSTRACT

The present invention discloses a system and method for providing real time dynamic interface for supervising individuals. The system is configured to monitor a plurality of agent data of each agent or individual in real time. The system is configured to analyze the call data and generate a call data set. The system is configured to analyze the call data set and generate a plurality of problem profiles. The system is configured to analyze the problem profiles to determine a plurality of actions for each problem profile and generate a plurality of action profiles for each problem profile. The system is configured to select at least one problem profile, determine at least one action profile for the selected problem profile and enables the system to implement the actions in the action profile. The system is configured to provide supervisors with recommended actions and real time graphical user interface to quickly monitor and engage with agents.

### TECHNICAL FIELD

The present invention relates generally to supervising individuals. More specifically, the present invention relates to a system and method for providing a system for determining problems, implementing actions including generating and updating a real time dynamic interface for supervising individuals based on event analysis profiles.

### BACKGROUND

Many organizations require supervisors to manage and oversee the activities of many employees or agents. Often, organizations requiring customer interaction often use call centers to provide services to their customers. Typically, a call center may have several supervisors and a large number of agents requires a tremendous amount of administration and supervision of agents to improve customer interaction. The management challenge often faced by call centers stems from a lack of real-time visibility into ongoing matters, especially the active calls that may demand immediate attention by supervisors.

Many of the problems from current systems to manage agents stem from a lack of visibility into the actions of the agents. Specifically, visibility into the activities, workload, and planned activities of each agent in real time. The lack of visibility makes it difficult for the supervisor to allocate his time efficiently and implement actions to make each employee or agent efficient and improve. Further, in the call center example, the supervisor may not be able to identify idle agents in real time and cannot utilize the available resources during a surge of call volumes received by the call center.

Another problem involves the inability to implement activities or provide guidance to agents promptly when the agent encounters complex issues or requires immediate guidance (i.e., during customer interactions). The inability to observe ongoing activities or calls in real time limits the supervisor's ability to intervene promptly to offer guidance during challenging situations. The net effect is service to the consumer which may impact the reputation and customer service quality being provided as well as the inability to provide timely feedback or recognize areas for improvement.

Therefore, there is a need for a system and method that provides supervisors visibility and insight into the real time activities of their employees or agents, creates and initiates real time activities based on identified problems, and provides a real-time dynamic display for supervisors to manage and supervise their workforce.

### SUMMARY OF THE INVENTION

The present invention discloses a system and method for providing a real time dynamic interface for supervising individuals. In one embodiment, the system comprises one or more agent workstations, one or more supervisor workstations and at least one server in communication with a database, the agent workstations and supervisor workstations. Each agent workstation is operable by at least one agent. Each supervisor workstation is operable by at least one supervisor.

The present invention includes a processing computer or server, or cloud-based system, processor readable memory comprising a set of software or program modules where the processor is configured to execute the software or program modules. The software or program modules include an agent monitoring module, a call data processing module, a problem detection module, an action profile module, a strategy scoring subsystem, a problem profile manager, an action profile manager and a dynamic interface module.

The agent monitoring module is configured to monitor one or more agent data elements of each agent or individual. The agent data includes call data, type of call, duration of call, availability of agent and actions or playbook used by the agent for a specific call, and client data. The call data processing module is configured to analyze the call data and generate a call data set. The analysis involves analyzing audio of the call data, transcribing the audio of the call data and transforming the call data into the call data set. The call data includes a plurality of features and attributes.

The problem detection module having a first machine learning model is configured to analyze the call data set and generate a plurality of problem profiles. The action profile module having a second machine learning model is configured to analyze the problem profiles to determine a plurality of actions for each problem profile and generate a plurality of action profiles for each problem profile.

The strategy scoring module is configured to analyze the problem profiles and the action profiles, and generate confidence scores and thresholds of the action profiles and the problem profiles. The problem profile manager is configured to select at least one problem profile. The problem profile is selected in real time based on based on call data including transcription of call and audio analysis.

The action profile manager is configured to determine at least one action profile for the selected problem profile and to initiate or enable the system to implement the actions set forth in the selected action profile. The action profile is selected in real time based on call data analysis and confidence score. The dynamic interface module is configured to display a dynamic interface based on active event analysis of the agents in real time. The interface comprises a plurality of cells. Each cell represents the respective agent. Each cell includes one or more graphical features to represent attributes of the agent. In one embodiment, the position of cells is dynamic.

The dynamic interface module is configured to enable to group the plurality of cells into one or more different groups of cells based on one or more parameters comprising location of agents, experience and client. The dynamic interface module is configured to arrange the position of the cells based on a performance of the agent. Each cell comprises one or more characteristics to represent a status or attributes of the agent.

In one embodiment, a method for providing real time dynamic interface for supervising individuals is disclosed. The method is executed in a system comprising one or more agent workstations, one or more supervisor workstations, and at least one server in communication with a database, the agent workstations and supervisor workstations. The server comprises a memory comprising a set of program modules and a processor configured to execute the program modules. Each agent workstation is operable by at least one agent. Each supervisor workstation is operable by at least one supervisor. The program modules include an agent monitoring module, a call data processing module, a problem detection module, an action profile module, a strategy scoring subsystem, a problem profile manager, an action manager and a dynamic interface module.

At one step, the agent monitoring module is configured to monitor one or more agent data of each agent or individual. The agent data includes call data, type of call, duration of call, availability of agent and playbook used by the agent for a specific call, and client data.

At another step, the call data processing module is configured to analyze the call data and generate a call data set. The analysis involves analyzing audio of the call data, transcribing the audio of the call data and transforming the call data into the call data set. The call data includes a plurality of features and attributes.

At yet another step, the problem detection module having a first machine learning model is configured to analyze the call data set and generate a plurality of problem profiles.

At yet another step, the action profile module having a second machine learning model is configured to analyze the problem profiles to determine a plurality of actions for each problem profile and generate a plurality of action profiles for each problem profile.

At yet another step, the strategy scoring module is configured to analyze the problem profiles, the action profiles, and generate confidence scores and thresholds of the action profiles and the problem profiles. The problem profile manager is configured to select at least one problem profile. The problem profile is selected in real time based on based on call data including transcription of call and audio analysis.

At yet another step, the action profile manager is configured to determine or select at least one action profile for the selected problem profile and implement the actions of the selected action profile. The action profile is selected in real time based on call data analysis and confidence score. At yet another step, the dynamic interface module is configured to display a dynamic interface based on active event analysis of the agents in real time. The interface comprises a plurality of cells. Each cell represents a respective agent. Each cell includes one or more graphical features to represent attributes of the agent. The position of cells, the color of the cells, the intensity of the color, the icon used in the cells, the size of the cell are all dynamic and can change in real time.

The dynamic interface module is configured to enable the system to group the plurality of cells into one or more different groups of cells based on one or more parameters comprising location of agents, experience of the agents, and the client. The dynamic interface module is configured to arrange the position of the cells based on a characteristic of each agent. Each cell comprises one or more characteristics to represent a status or attributes of the agent.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates a flowchart of a method for monitoring and managing call data of the agents in real time, according to an embodiment of the present invention.

FIG. 2 exemplarily illustrates an environment of a system for providing real time dynamic interface for supervising individuals, according to an embodiment of the present invention.

FIG. 3 exemplarily illustrates an environment of a system for detection of problem profiles and action profiles using machine learning model, according to an embodiment of the present invention.

FIG. 4 exemplarily illustrates an environment of the system connected to a call center network, according to an embodiment of the present invention.

FIG. 5 exemplarily illustrates a flowchart of a method for providing real time dynamic interface for supervising individuals, according to an embodiment of the present invention.

FIG. 6 exemplarily illustrates a dynamic user interface for supervising agents, according to an embodiment of the present invention.

FIG. 7 exemplarily illustrates a dynamic user interface for supervising agents, according to another embodiment of the present invention.

FIG. 8 exemplarily illustrates a dynamic user interface displaying two groups of agents, according to another embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

The present invention discloses a system and method for providing real time dynamic interface for supervising individuals. The system is configured to actively monitor agents in an organization which may be in one or many locations. The system is further configured to provide supervisors in the organization with real-time data, determine problems, determine and invoke actions to take based on the problems, and a real time graphical user interface to quickly monitor and engage with agents. The present invention may be used in any organization or situation where a supervisor needs to monitor and supervise several or many employees or agents. In particular, the present invention is useful in assisting supervisors managing many agents for customer support calls and will be used as an exemplary embodiment of an implementation of the present invention.

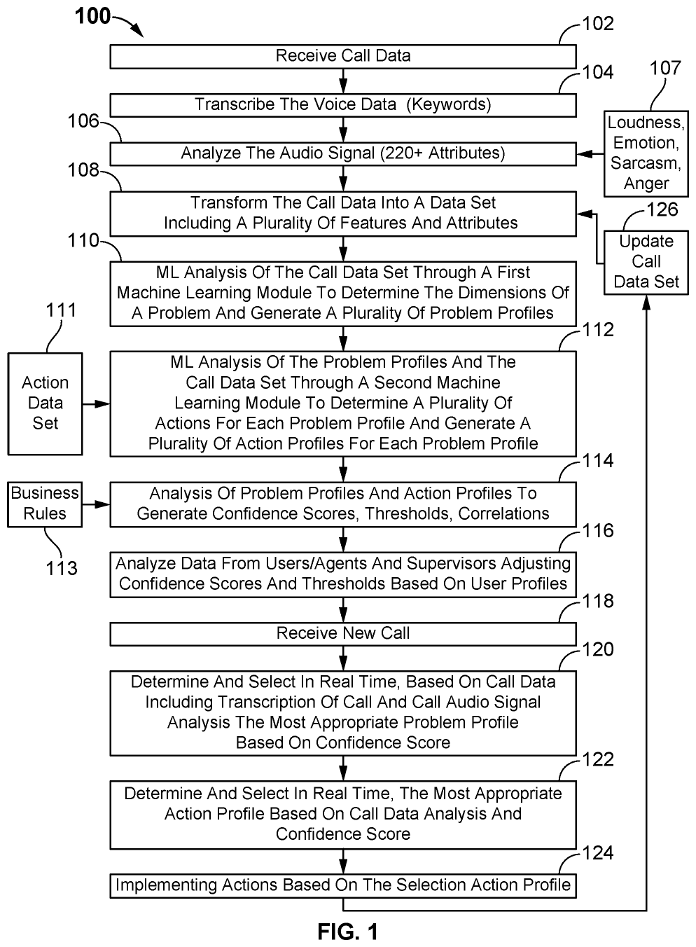

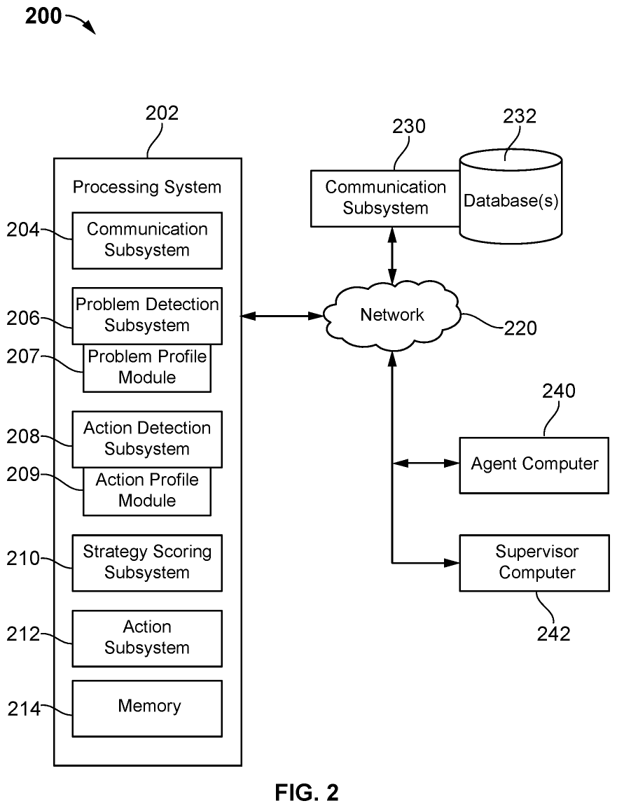

As seen in FIG. 1, which provides an exemplary flowchart, the system employs a method 100 for monitoring and managing call data of agents in real time. The method 100 is executed or implemented (see FIG. 2) in a computing system 200 comprising at least one server or processing system 202 in communication with at least one database 232. The system 200 further comprises one or more agent workstations 240 and one or more supervisor workstations 242. Each agent workstation 240 is for use by at least one agent or individual and each supervisor workstation 242 is for use by at least one supervisor. The agent workstation 240 and the supervisor workstation 242 are in communication with the processing system 202 and the database 232. The server or processing system 202 comprises at least one memory 214 storing a set of program modules and at least one processor configured to execute the program modules.

The agent workstation 240 and the supervisor workstation 242 may be, for example, a desktop computer, a laptop computer, a mobile phone, a personal digital assistant, and the like. The server or processing system 202 could be any suitable server(s) for storing information, data, programs, and/or any other suitable content. In an exemplary embodiment, the processing system 202 is a cloud-based server system. However, the processing system 202 could be could be a hardware and/or software server, a workstation, a desktop, a laptop, a tablet, a mobile phone, a mainframe, a supercomputer, a server farm, and so forth. Although the server 202 is illustrated as a single device, the functions performed by server could be performed using any suitable number of computing devices.

Referring back to FIG. 1, the method 100, starts at step 102, when the system 200 received a call. The call would be routed by the system 200 to an agent's workstation or computer. At step 104, the system 200 is configured to transcribe the data and does process the call to transcribe the call into data. Further, keywords are extracted from the transcribed voice data for analysis. At step 106, the system 200 is configured to analyze the audio signal and does process the audio signal into additional call data. At step 107, the system analyzes the audio signal to determine numerous attributes and characteristics of the audio signal, for example, loudness, emotion, sarcasm, anger, excitement and other attributes. The audio signal analysis includes the ability to analyze over 220 attributes in the voice or audio signal.

At step 108, the system 200 transforms the call data into a call data set. The call data set includes call data from many calls, both historical and real-time call data. The call data set comprises a plurality of features and attributes. At step 110, the system analyzes the call data set using a first machine learning module to determine the problems or types of problems being received, the dimensions of each problem, and to generate a plurality of problem profiles.

At step 112, the system analyzes the call data set and the problem profiles using a second machine learning model to determine a plurality of actions for each problem profile and generate a plurality of action profiles for each problem profile. The system also makes use of one or more action data sets 111 to determine the action profiles. The action data set(s) 111 may include actions already generated by the action machine learning model as well as actions generated or provided by an organization.

At step 114, the system analyzes the problem profiles and the action profiles to generate confidence scores, thresholds, correlations. The system may also implement business or action rules 113 to alter or generate the confidence scores, thresholds and correlations. The business rules 113 can be implemented to prioritize the type of call (i.e., new customer, cancellation, etc.), preferred actions or playbooks, and for establishing pre-set correlations. At step 116, the system analyzes data from the users/agents and supervisors and can adjust the confidence scores and thresholds based on user profiles. Thus, allowing the problem profiles and action profiles to be tailored to the organization or business as well as tailored to the specific agent or supervisor.

At step 118, the system receives a new call with new call data. At step 120, the system determined, in real time, based on call data from the new call, including transcription of the new call and call audio signal analysis, the most appropriate problem profile based on the confidence scores and correlations.

At step 122, the system determines and selects in real time, the most appropriate action profile, from the selected problem profile, based on the call data analysis and confidence score. At step 124, the system implements actions for the supervisor and/or the agents based on the selected action profile. Specifically, the system can automatically implement various actions to take from the selected action profile. Such actions might include: (1) provide a set of actions or playbook for the agent to take to manage the consumer that called; (2) identify additional training the agent might need; (3) notify (i.e., text message or notification on the supervisor's computer) the supervisor's assistance is needed on the call; (4) pre-load a message into a chat window the supervisor can send the agent' and/or (5) update the graphical user interface of a supervisor's monitoring system to provide real time feedback to the supervisor. The actions listed are merely examples and could include many actions the system determines, in real time. At step 126, the system then updates the call data set with the data from the received call. As seen in FIG. 1, the system of the present invention provides a method to analyze real time data, identify a myriad of problems or problem profiles, identify a myriad of actions or action profiles for each problem profiles, select a problem profile and action profile based on real time data including threshold analysis, and implement a set of actions.

FIG. 2 provides an exemplary embodiment of a computing network or system 200 for providing real time dynamic interface for supervising individuals, according to an embodiment of the present invention. The computing network the system 200 comprises a processing system 202, one or more databases 232 in communication with the processing system 202, and one or more remote computing devices 240, 242 in communication with the processing system 202. The processing system 202 may be implemented as a closed or behind the wall system or as one or more cloud-based server systems. The processing system 202 also comprises a communication subsystem 204 for communicating, through a network 220, with the database 232 or with one or more remote computers 240, 242. The remote computers 240, 242 might for instance be the computer used by an agent 240 and the computer used by a supervisor 242. The one or more databases 232 could be remote and include a communication subsystem 230 for enabling communication via the network 220 with the processing system 202. Further, the remote computers 240, 242 would have communication systems for communication, via the network 220, with the processing system 202.

The network 220 generally represents one or more interconnected networks, over which the agent workstation 240, supervisor workstation 240 and the server or processing system 202 could communicate with each other. The network 220 may include packet-based wide area networks (such as the Internet), local area networks (LAN), private networks, wireless networks, satellite networks, cellular networks, paging networks, and the like. A person skilled in the art will recognize that the network 220 may also be a combination of more than one type of network. For example, the network 220 may be a combination of a LAN and the Internet. In addition, the network 220 may be implemented as a wired network or a wireless network or a combination thereof.

The processing system 202 further comprises a problem detection subsystem 206, an action detecting subsystem 208, a strategy scoring subsystem 210 and action implementation subsystem 212. The problem detection subsystem 206 includes a problem profile machine learning module 207 and the action detection subsystem 208 comprises an action profile machine learning module 209.

The processing system 202 comprises at least one memory for storing a set of program or software modules and at least one processor configured to execute the software program or software modules stored in the memory. The program modules include the problem detection subsystem 206, the action detecting subsystem 208, the strategy scoring subsystem 210 and action implementation subsystem 212.

The modules further include an agent monitoring module. The agent monitoring module is configured to actively monitor the agents. The agent monitoring module is further configured to perform analysis of agent data. The agent data includes information related to the client being handled by the agent or client data, type of call received by the agent, duration of call, availability of agent and playbook used by the agent for a specific call. The availability of agent includes determining if the agent is online, offline, at break or at lunch. The agent data further includes biographical data, experience data and training data.

The modules further include a call data processing module configured to process the call data. The processing of call data includes transcription of call data and determining keywords from the transcription. Further, audio voice signal of the call data is analyzed. In an example, the audio voice signal is analyzed with 220+ attributes, which is used for determining the sentiment of caller and agent. The processing system 202 is configured to use machine learning model for analysis of call data and agent data.

The problem detection subsystem 206 includes a problem detection module 207 configured to use a first machine learning model for multi-dimensional analysis of the call data set to identify problem attributes, keywords, and correlations of the problem and to generate problem profiles. The problem detection subsystem 206 and the problem profile module 207 are configured to generate myriad of problem profiles.

The action detection subsystem 208 includes an action profile module 209 configured to use a second machine learning model for multi-dimensional analysis to determine various actions to take for each problem profile. The multitude of actions which can be implemented based on a problem profile are stored as action profiles. The actions can be in a grouped set of actions, a hierarchy set of actions., and can include rules or business rules implemented which establish certain defined actions. In one example, the action profile could include a set of sequential actions to be taken for a selected problem profile. By way of example, the action profile could employ a hierarchy or grouped set of actions including: (i) providing the agent with a set of actions or playbook for handling a call; (ii) initiating a call with the consumer at a set time the next day; (iii) sending the consumer a text message the next day; and (iv) sending a notification with suggested actions to a supervisor. The system or actions can also extend an action such that if the call to the consumer does not go through it implements a logical schedule for when to attempt another call the following day at a different time. The grouped actions can be tailored based on a specific customer, client, or caller attributes. The action detection subsystem 208 is configured to generate these action profiles, while following the business rules but also taking into account the call data and historical success rates of actions for similar problems and problem profiles. The action detection subsystem 208 is configured to generate a myriad of action profiles for each problem which are optimized for a positive outcome of the problem.

The strategy scoring subsystem 210 is configured to analyze the problem profiles and the action profiles and generate confidence scores and thresholds of the problem profiles and the action profiles. These confidence scores and threshold values are based on or ties to the call data set, keywords from translation, sentiment and attributes from the audio signals, correlations, the action data, business rules, agent attributes, supervisor attributes, and the historical success rate of the actions. Further, the one or more actions within an action profile are grouped and sequenced. Each action can be assigned with a confidence score based on various factors to prioritize or rank actions, indicating their perceived effectiveness or suitability in addressing specific scenarios.

The problem profile module 207 also acts as a problem profile manager which is configured to determine or select at least one problem profile based on the confidence scores and thresholds when a new call is received and analyzed. The problem profile selection process can be based on one attribute meeting a confidence score or threshold or a multi-factor analysis where multiple attributes meet multiple confidence scores or thresholds. The action profile module 209 also acts as an action profile manager which is configured to determine or select at least one action profile based on the confidence scores and thresholds once the problem profile is selected and the new call is analyzed. The action subsystem 212 or action manager is configured to enable to implement the action profile including implementing the actions. The processing system 202 is configured to provide actions or playbooks to the agents as well as actions or playbooks for supervisors. The processing system 202 is also configured to provide a graphical user interface (GUI) to present the playbooks and/or actions to the agents and a playbook and/or actions to the supervisor, respectively. The processing system 202 is also configures to take the real time call data and agent data and provide a graphical user interface, as will be described in more detail below, displaying the real time activities to the supervisor.

The system 200 of the present invention is able to actively monitor employee or agent activities including data analysis on: (1) calls including client, type of call, and duration; (2) agent data including biographical data, experience, and training; (3) status including online, offline, breaks, lunch, training sessions; and (4) problem detected, problem profile selected, action profile selected, and actions or playbook being used.

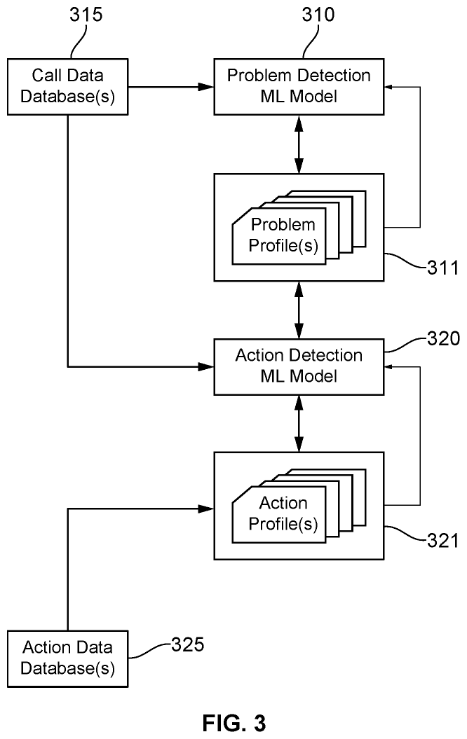

FIG. 3 provides an exemplary illustration of the system for detection of problems, generation of profiles, and the generation of action profiles using machine learning models according to an exemplary embodiment of the present invention. The processing system 202 (see FIG. 2) further comprises a problem detection machine learning (“ML”) model 310 and an action detection ML model 320. The problem detection ML model 310 and the action detection ML model 320 are configured to access the call data database(s) 315. In one embodiment, the call data database(s) 315 may include information related to the historical call data. This historical call data could include the type of call, keywords from translation, sentiment and attributes from the audio signal analysis, correlations, action data, business rules, agent attributes, and supervisor attributes among other data elements. The problem detection ML model 310 or the first machine learning model along with the problem detection module is configured to analyze the call data set where the machine learning problem detection software can identify problems and generate a plurality of problem profiles 311.

The action detection ML model 320 or the second machine learning model along with the action profile module is configured to analyze the problem profiles 311, the call data database(s) 315, and the action data database 325 to determine a plurality of actions for each problem profile 311 where the machine learning action detection software can identify and generate a plurality of action profiles 321 for each problem profile 311. In one embodiment, the action profiles 321 may be stored in the action data database(s) 325.

The action profile module 209 is configured to determine actions consistent with the business rules set by the client. The processing system 202 is configured to enable the client or business to set business rules. In an exemplary embodiment, the set of business rules can prioritize the types of call (i.e., a new customer or a cancellation request, etc.), preferred actions or adjusted thresholds for certain actions, preferred action sets or playbooks, as well as pre-set correlations. By way of example, a correlation could be linking a set of actions such as, in the event of a cancellation request, invoke a certain playbook and notify the supervisor to join the call. Alternatively, a correlation could be linking certain keywords (from the transcription) and sentiments (from the audio signal analysis) from real-time call data to a certain problem profile and action profile.

The system 200 is configured to: (1) utilize the problem detection machine learning model 310 to detect problems and generate problem profiles; (2) utilize the action detection machine learning model 320 to detect optimal actions and generate action profiles. The set of actions are also referred to as playbooks. The playbooks include rules, actions and strategies to optimize the outcome of an identified problem. The system 200 is also configured to create a myriad of playbooks for each problem or problem profile. The system is further configured to provide confidence score for actions. The system 200 is further configured to provide playbooks to the agents and provide playbooks or actions for supervisors.

The system 200 is also configured to analyze real time call data and determine the best problem profile 311 and action profile 321 to invoke. The selection of the problem profile 311 and action profile 321 to invoke is based on analyzing the real time call data, determining various attributes of the call, determining a call type and a call confidence score and selecting the problem profile 311 and action profile 321 based on the call type and confidence score compared to the threshold values of the myriad of problem profiles 311 and action profiles 321. The system 200 is further configured to provide multiple threshold calculations for triggering actions to optimize the outcomes. The system 200 is also configured to provide a graphical user interface (GUI) to present the playbooks and/or actions to the agents and the supervisor, respectively, and for providing a GUI to the supervisor of real time agent activities.

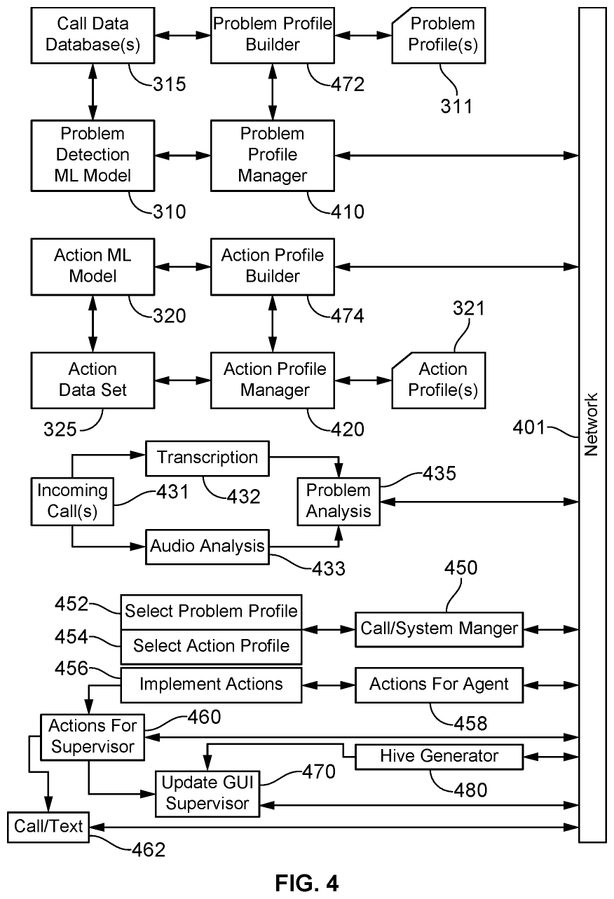

FIG. 4 provides an illustration of the networked environment of the system 200 connected to a call center network 401, according to an embodiment of the present invention. The system 200 is typically provided as a platform as a service which connects to the call center network 401. The system 200 is configured to receive incoming call(s) 431 and process the call. The system 200 is configured to perform audio analysis 433 and transcription 432 of the received call. Further, the system 200 then analyzes the incoming call data for problem analysis 435. The system 200 includes or comprises the call data database(s) 315, a problem profile builder 472, the problem detection ML model 310 and a problem profile manager 410. The problem detection ML model 310 and problem profile builder 472 are configured to generate the problem profile(s) 311 from analysis of the call data database 315 as well as new incoming calls 431.

The system further comprises an action ML model 320, an action profile builder 474, action data set 325 and an action profile manager 420. The action ML model 320, the action data set 325, and the action profile builder 420 are configured to generate a plurality of action profiles 321 for each problem profile 311.

The call system manager 450 is configured, upon analysis of the incoming call 431, to communicate the incoming call problem analysis 435 to the problem profile manager 410 and the action profile manager 420, via network 401. The problem analysis 435 includes relevant data, keywords, problem type, confidence score and related information. The problem profile manager 410 determines the selected problem profile 452 from the set of problem profiles 311 and communicates the information to the call system manager 450. The action profile manager 420 determines the selected action profile 454 from the set of action profiles 321 and communicates the information to the call system manager 450.

The system 200, then implements the actions 456 from the selected action profile 454 including communicating and/or implementing the actions for agent 458 and actions for the supervisor 460. The actions for agent 458 may include providing the agent with a playbook of actions to take on the call with the consumer and may include updating the GUI of the agent. The actions for supervisor 460 may include sending the supervisor a supervisor playbook, calling or texting 462 the supervisors' phone, or updating the supervisors' GUI 470.

Since the system 200 of the present invention is able to handle many incoming calls connected to many agents, the supervisor may have numerous real time updates and actions. To address this, the present invention provides a unique and novel graphical user interface (referred to herein as the “Hive”) which can display real-time data of all agents on the network 401. The Hive generator 480 is configured to receive or retrieve real time data of all or selected agents on the network 401, generate or update the Hive graphical user interface of the supervisor 470 and transmit the Hive data or GUI to the supervisors' workstation or computer 242 (see FIG. 2).

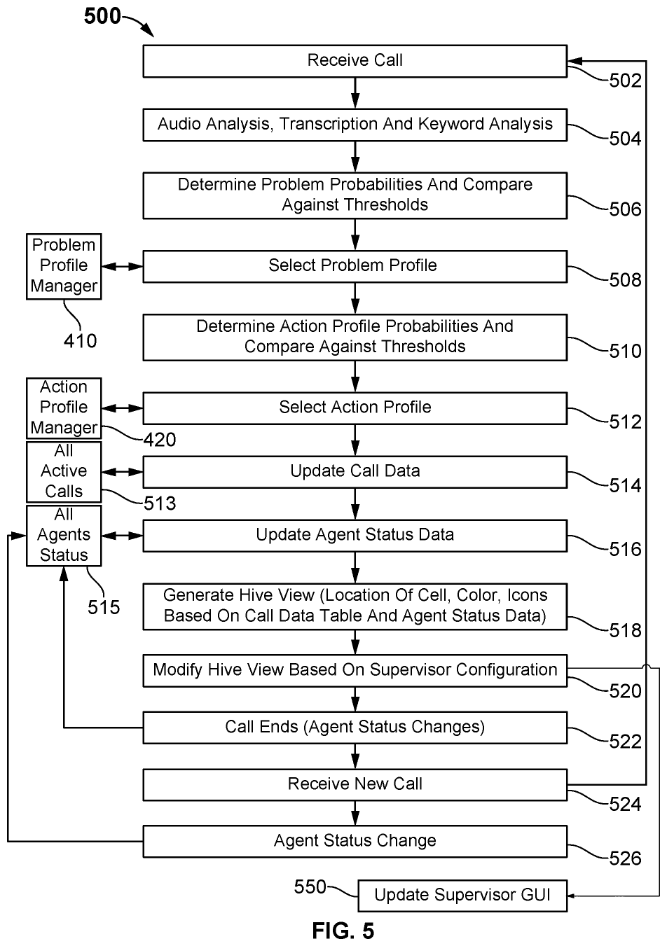

FIG. 5 provides an exemplary flowchart illustration of a method 500 for providing real time dynamic interface for supervising individuals, according to an embodiment of the present invention. The method 500 is executed in the system explained with respect to FIGS. 2-4.

At step 502, the server or processing system 202 is configured to receive a call such as a consumer call into a call center. At step 504, the server or processing system 202 performs audio analysis of the audio signal, performs transcription of the call data, and performs keyword analysis on the transcribed call data.

At step 506, the server or processing system 202 is configured to determine Problem analysis on the call, determine scores or probabilities and compare against thresholds of the problem profiles. At step 508, the problem profile manager 410 is configured to select a problem profile based on the incoming call analysis, score, and thresholds. At step 510, the server or processing system 202 is configured to determine action profile probabilities and compare against the action profile thresholds. At step 512, the action profile manager 420 is configured to select an action profile based on the selected problem profile, the incoming call analysis, score, and thresholds.

At step 514, the server or processing system 202 is configured to update call data for that specific call with the actions from the selected action profile as well as update all the data for all active calls 513. At step 516, the server or processing system 202 is configured to update the agent status data for that specific agent as well as update all agent status data 515.

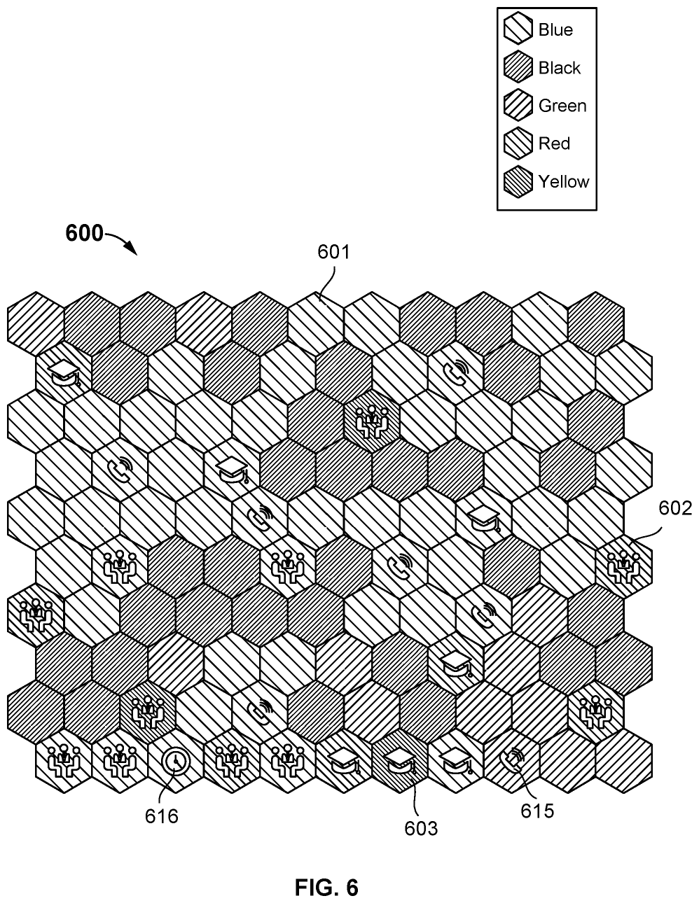

At step 518, the server or processing system 202 is configured to generate the Hive graphical user interface. The Hive graphical user interface will be described in more detail below in conjunction with FIGS. 6-8. However, the Hive includes a cell for each agent or employee and the generating of the Hive view includes determining the location of each cell in the display, the color of each cell, the selection of an icon(s) within the cell, and agent status. The determining is based on data within the all-active calls dataset 513, the all agent status dataset 515, and other information or data in the system 200.

At step 520, the server or processing system 202 is configured to modify the Hive view based on the supervisors' attributes or specific configurations. The modified Hive view, or updates to the view, can then be displayed or communicated (step 550) to the supervisors' computer or workstation 242 (FIG. 2). At step 522, the call between the consumer and the agent ends and the status of the agent changes, which is updated in the system including the all agent status dataset 515. At step 524, the server or processing system 202 is configured to receive a new call or new call data. At step 526, the status of the agent changes including the all agent status dataset 515. The change in status of the agent or all agent status dataset 515 invokes step 516 which then forces the Hive view to be updated (steps 518 and 520). The update of the hive view can then be communicated, step 550, to the supervisor's computer 242.

As more fully described in conjunction with FIGS. 6-8, the Hive graphical user interface is a dynamic display. In an exemplary embodiment, the display comprises a plurality of cells like a honeycomb. Each cell represents an agent of the organization or call center. Each cell comprises one or more characteristics to represent the status of the agent. The characteristics of each cell includes, but is not limited to, color, icons, shape, sub-shape, markings, flashing cells, dynamic sizing and resizing, split cells, and different borders on the cell. The agent status includes online, offline, training, in meeting, on call, off call, ratings, training or level, awards, on break, and at lunch. In one example, the characteristics of the cell could provide information related to the location of the agent including location in a call center or, if working remotely, the location they are located globally. In a second example, a flashing cell could represent an alert to important actions or issues the supervisor should know. In another example, the dynamic sizing and resizing represents importance of a task or action, or of a problem. In another example, each cell could be split or divided, and each portion of the cell has a characteristic to display sentiment of the caller compared to sentiment of the agent. In another embodiment, the dynamic display comprises one or more groups of cells. The grouping of could represent agents of different locations, agents for different client organizations, different skill or training levels, or different departments.

The dynamic display is configured to alter the GUI display based on actions, events, correlations and thresholds. The dynamic display could be configured to alter the display based on problem profiles, for example, the rank or weight of problem profiles, based on client profiles, based on desired outcome, based on agent profile, or based on confidence score. The dynamic display is further configured to alter display based on action profiles, for example, rank or weight of problem profiles or action profiles, based on client profiles, based on desired outcome, based on agent profiles, or based on confidence score. The dynamic display is further configured to make updates to the graphical user interface based on the preferences of the supervisor's display preferences or configurations. The communication system 204 sends a communication signal to the supervisors' computer 242 to modify or update the display of the supervisors' computer 242 in real time.

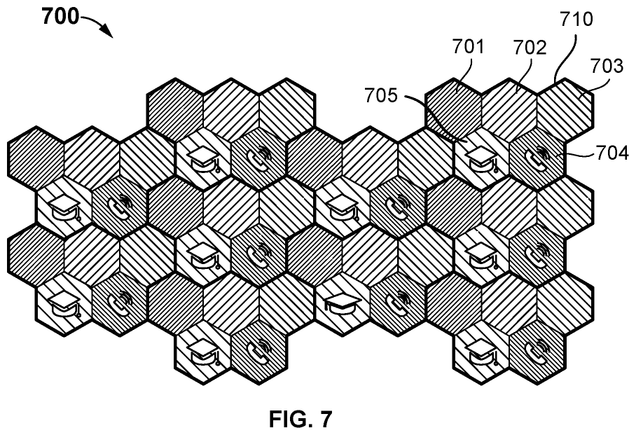

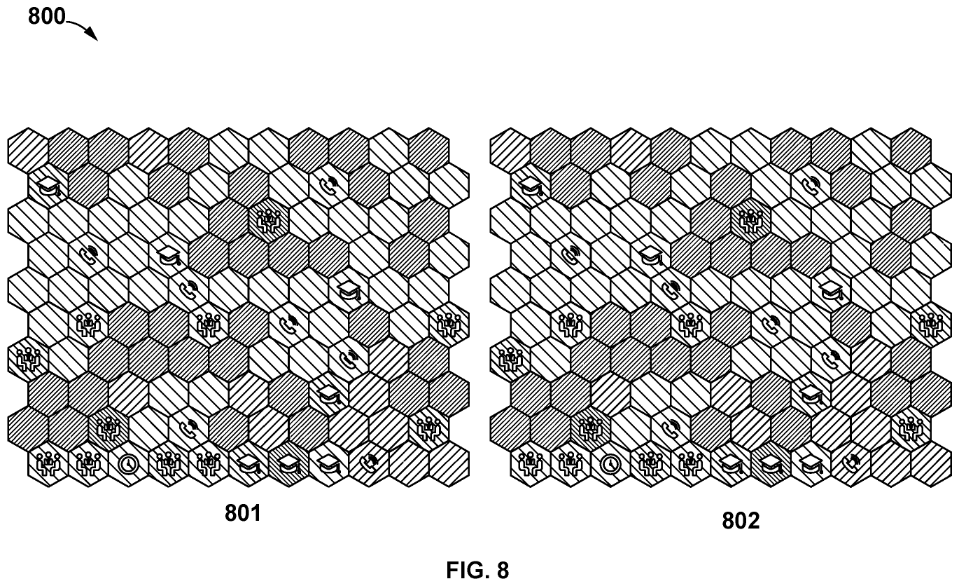

FIG. 6 provides an illustration of the Hive dynamic graphical user interface 600 for supervising agents, according to an exemplary embodiment of the present invention. FIG. 7 exemplarily illustrates a dynamic user interface 700 for supervising agents, according to another embodiment of the present invention displaying grouping of cells or agents. FIG. 8 exemplarily illustrates a dynamic user interface 800 displaying two groups of agents simultaneously, according to another embodiment of the present invention. Referring to FIG. 6 to FIG. 8, the dynamic display provides a Hive like graphical user interface (GUI) display.

The Hive GUI 600 includes a plurality of cells 601, 602, 603. Each cell 601, 602, 602 represents a respective agent on the network. Each cell 601, 602, 603 includes one or more graphical features that represent attributes of the agent or a call the agent is handling. In a first example, a phone icon 615 could be displayed within a cell to illustrate that the agent is on the phone such as on a customer support call. In a second example, a clock dial 616 could be displayed for when an agent is on a break. A myriad of icons can be used including icons such as a phone icon for phone calls, a graduation cap icon for training, a clock dial icon for breaks, and a group of people icon for a meeting. The icons can vary, be expanded, and could be tailored to each type of action the system wants to identify.

Further, the cells 601, 602, 603 of the Hive 600 may be static or blank to represent an inactive status. The size of the Hive 600 is also dynamic and could increase or decrease based on an agent “signing in” (cell is added) or “signing out” (cell is removed), in real time. Alternatively, some other parameter (of a respective agent) could trigger whether a cell representing such agent is visually shown or not shown.

Another variance could be the color of each cell 601, 602, 603 is mapped to certain aspects of the agent or a call. For example, the color of particular cells 601, 602, 603 can graphically convey information such as using a red color for a hostile customer call (based on keyword analysis of the call or sentiment based on audio signal analysis) or a green color to represent call analysis indicates the agent is correctly handling a call or implementing a trusted playbook. Other examples could include black to represent an inactive agent, blue to represent an agent that is unavailable (i.e., in a meeting), or yellow to indicate an agent who has signaled he needs assistance handling a call. The intensity of the color could also be variable based on one or more factors. For example, the cell color could be a dark red for a very hostile call or a lighter shade of red for less confrontational call. Alternatively, the color for new agents might be more intense than experienced agents with the goal of enabling the supervisor to quickly determine which agents might need the supervisor's attention.

The system may utilize relational database comprising data tables, that represent the Hive 600. “Primary keys” and “foreign keys” could be used in such tables to interrelate the tables. Each cell 601, 602, 603 (for a respective agent) of the Hive 600 can be represented by a respective table (which may include sub-tables). Each table (i.e., data table) could include variables that control respective graphical features of a particular cell. For example, one variable control could be “mapped to” the color of particular cell and one could be mapped to the icon. A particular variable could be adjusted based on an observed triggering event(s), so as to represent a particular attribute of the agent. Thresholds could be used to assess whether an event is present or not present. Further, some graphical features could be determined or controlled by multiple parameters/variables.

In one embodiment, the position of the cells 601, 602, 603 representing each agent within the Hive 600 could be dynamic. In one example, the position of the cells of better performing agents could be displayed near the top of the hive and the position of the cells of poor performing or newer agents are shown at the bottom of the Hive 600. Such placement would allow the supervisor to focus on those cells more likely to need his/her attention. In a further embodiment, the position of the cells 601, 602, 603 of the Hive 600 could dynamically change in real time based on one or more parameters.

Referring to FIG. 7, the cells 701, 702, 703, 704, 705 could be grouped based on one or more parameters. In one embodiment, the parameters include, but not limited to, the client, the location of the agents, or the experience of the agents. The cells 701, 702, 703, 704, 705 could be displayed with a border 710 which encapsulates those cells. The border 710 could be a colored border or a thick border. Alternatively, the cells 701, 702, 703, 704, 705 could be grouped by having a portion of each cell have a similar matching element. For example, each cell 701, 702, 703, 704, 705 might have the same color in an upper left region of each cell.

Referring to FIG. 8, the system could also be used to display more than one Hive display on the same graphical user interface 800. As seen in FIG. 8, the graphical user interface 800 could have two or more Hives 801, 802 which are displayed side by side. The Hives 801, 802 could be used to display multiple clients or multiple call centers simultaneously.

The Hive 600 (as seen in FIG. 6) also provides the supervisor with additional information. Upon scrolling over the cells 601, 602, 603, each cell could display information, including, but not limited to, agent name, level, performance, location, time on shift or time left on shift, and the client name. If the agent is on call, the information could also include, but is not limited to, any customer information (i.e., name, phone number, calling location), the product or reason they are calling, the actions or playbook implemented by the system, the keywords transcribed, the full transcription of the call, and time on call. As previously mentioned, the colors of the cell can be configured to darken or lighten based on many factors such as time on call, sentiment, keywords, level of agent, or other parameters.

The supervisor also can initiate several actions from each cell. The supervisor can click on a cell to initiate a myriad of actions including listening to the call, join the call, send a message (i.e. text or chat message) to the agent, or to transfer the call to another agent. The supervisor can also reassign an agent to another client and the system would notify the agent. The system can also be configured to save the data of the Hive 600 enabling: (1) analytics to be conducted to identify times and events which could be improved or identify times when the system and team were highly successful; and (2) allow the supervisor to “rewind” a period a time of the Hive 600 display, so as to see how a particular agent's attributes changed over time or to review call data with an agent for training purposes.

The system of the present invention helps to improve the overall computer system, by providing a problem profile manager and an action profile manager. Specifically, the software of the present invention uses machine learning software to analyze data and identify problems seen through the data. Then, the system generates a myriad of problem profiles from the identified problems and then the problem profile manager manages those problem profiles to select the most appropriate problem profile when real time data is analyzed. Effectively, selecting the most likely and appropriate problem profile based on analysis of real time data the system is capturing. Further, the system uses machine learning software to analyze the problem profiles against actions, in an action dataset, the system can implement, or employees or agents can implement, to generate a myriad of action profiles. The system then has an action profile manager to manage the action profiles and select the most appropriate action profile based on the selected problem profile and analysis of real time data. Thus, the present invention improves the computer system by employing a problem profile manager and action profile manager to quickly determine the most appropriate problem and actions to take when analyzing new data improving the efficiency by which problems are addressed and how to address the identified problems.

The present invention also provides a system which transforms data into one or more graphical user interfaces displaying real time activities of employees, call agents or supervisors. Specifically, the system captures data on: (1) each employee or agent; (2) each supervisor; and (3) each call, or event seen by the system. The system captures data, in real time, associating a call or event to an agent, determining keywords from transcribing a call, determining the sentiment from audio analysis of a call, determining the real time status of an agent, and determining the problem profile and action profile implemented. The data is then transformed into real time agent data table for all agents, or a data table for each agent. The transformed agent table data is then used to generate a graphical user interface showing each agent as a cell within a plurality of cells (i.e., the Hive), where the color of the cell, the icon within a cell, the size of a cell, and the location of a cell within the GUI are determined by the transformed agent data table. The system generates the GUI and displays the GUI on a supervisor's computer display. The GUI can also be modified by transforming the GUI data from the agent tables based on a supervisor's preference or real time status.

In addition, the system provides an inventive and novel concept in the management and operation of call centers and agents within a call center. Specifically, the system of the present invention: (1) analyzes real time call data as described herein; (2) determines a real time status of each agent; (3) determines a problem profile from the call data analysis; (4) determines an action profile from the selected problem profile; (5) implements the actions from the selected action profile; and (6) updates a graphical user interface on a supervisor's computer display. The novel GUI provides a visual display to the supervisor showing real time status of each agent, the sentiment or type of problem the agent is handling if on a call, and adjusting the color, size, location, icon within a cell, for each agent cell within a plurality of agent cells displayed in the GUI. The GUI can also display or provide information on the problem profile selected, the action profile selected, and the actions being implemented for each call.

The systems and methods of the present invention in the described embodiments may be implemented as a system, method, apparatus or article of manufacture using programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMS, DRAMs, SRAMs, Flash Memory, firmware, programmable logic, etc.), etc. The code implementing the described operations may be further implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

In an embodiment of the invention, the systems and methods can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, tablets, portable media players and personal digital assistants.

As noted above, the processing machine used to implement the invention may be a suitable computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system (OS). Thus, embodiments of the invention may include a processing machine running the Unix operating system, the Apple iOS operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system (such as macOS™), the Apache operating system, an OpenStep™ operating system, the Android™ operating system (and variations distributed by Samsung, HTC, Huawei, LG, Motorola, Google, Blackberry, among others), the Windows 10™ operating system, the Windows Phone operating system, the Windows 8™ operating system, Microsoft Windows™ Vista™ operating system, the Microsoft Windows™ XP™ operating system, the Microsoft Windows™ NT™ operating system, the Windows™ 2000 operating system, or another operating system or platform.

The systems and methods of the invention may utilize non-operating systems (aka serverless architecture) as well for distributed processing. In the processing of the invention, services on cloud computing networks leveraging systems like AWS (as offered by Amazon Web Services, Inc.), BlueMix (as offered by IBM), and Microsoft Azure, can perform data collection services using varying technologies that are spun up on demand using tools like Chef to create container based deployments like Docker, or non-container compute services (e.g. AWS Lambda).

The invention may use or provide real-time analytics processing that may use scale on demand to the users in the system, in accordance with at least one embodiment of the invention. Such offerings as AWS lambda and Kinesis (as offered by Amazon Web Services, Inc.) are among those that may be used in implementation of the invention. For example, AWS Lambda may be utilized to execute code (to perform processes of the invention) in response to various triggers including data changes, shifts in system state, or particular action taken by users. Similarly, in an embodiment, the OS (operating system) of the invention might be encapsulated in an EC2 instance (as offered by Amazon Web Services, Inc.) or multiple instances for deployment.

Another example of a traditional system is a device in the electrical distribution system that may speak a proprietary protocol or an older standardized protocol such as DNP3. In order to converge such a device to the modern grid it may be necessary to marshal its ‘native’ protocol into a new protocol such as IEC 61850. Further, is often desired to do so in such a way that allows security policy to be specified and enforced independently of the application behavior, and it is also often necessary to participate more fully in field-area networks that may require localized edge processing and interaction over other protocols with other devices at the edge such that a portion of the distribution system may reasonably take some action independently of coordination through a centralized head-end. The present invention allows such systems to be realized, by for example but not limited to 1) allowing domain experts to quickly and efficiently specify application layer behavior independently of deep protocol expertise, 2) allowing multiple protocols to be bound to that application via an abstract data set, which allows different protocols to transparently interact with elements in that data set as necessary, 3) allowing a natural partitioning of application logic independently of the underlying protocols, 4) allowing an architecture where protocol service behavior can be constrained by security policies (e.g. firewalling) independently of how an application layer will operate over that protocol.

Itis appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner, such as over a network of over multiple networks. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

Further, multiple applications may be utilized to perform the various processing of the invention. Such multiple applications may be on the same network or adjacent networks, and split between non-cloud hardware, including local (on-premises) computing systems, and cloud computing resources, for example. Further, the systems and methods of the invention may use IPC (interprocess communication) style communication for module level communication. Various known IPC mechanisms may be utilized in the processing of the invention including, for example, shared memory (in which processes are provided access to the same memory block in conjunction with creating a buffer, which is shared, for the processes to communicate with each other), data records accessible by multiple processes at one time, and message passing (that allows applications to communicate using message queues), for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, C#, Objective C, COBOL, dBase, Forth, Fortran, Java, Modula-2, Node.JS, Pascal, Prolog, Python, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for providing real time dynamic interface for supervising call center agents, comprising:
one or more agent workstations, each agent workstation is operable by at least one agent;
one or more supervisor workstations, each supervisor workstation is operable by at least one supervisor, and
at least one server in communication with a database, the agent workstations and supervisor workstations, wherein the server comprises a memory comprising a set of program modules and a processor configured to execute the program modules, wherein the modules comprise:
an agent monitoring module configured to monitor a plurality of agent data of each agent, wherein the plurality of agent data includes call data, type of call, duration of call, availability of agent, and actions used by the agent for a specific call, and client data;
a call data processing module configured to analyze a plurality of call data and generate a call data set, wherein the analysis involves analyzing audio of the call data, transcribing the audio of the call data and transforming the plurality of call data into the call data set, wherein the plurality of call data includes a plurality of attributes;
a problem detection module having a first machine learning model configured to analyze the call data set and generate a plurality of problem profiles;
an action profile module having a second machine learning model configured to analyze each of the plurality of problem profiles to determine a plurality of actions for each problem profile and generate a plurality of action profiles for each problem profile,
a strategy scoring module configured to analyze the problem profiles and the action profiles and generate confidence scores and thresholds of the action profiles and the problem profiles,
a problem profile manager configured to select at least one problem profile for each new call based upon analysis of call data,
an action profile manager configured to determine at least one action profile for the selected problem profile for each new call based upon analysis of call data, wherein upon selection of the at least one action profile the system implements the plurality of actions within the selected at least one action profile; and
a dynamic interface module configured to display a dynamic interface based on active event analysis of the agents in real time, wherein the interface comprises a plurality of agent cells, wherein each agent cell represents a respective agent of the at least one agent, wherein each agent cell of the plurality of agent cells includes at least one graphical attributes to represent attributes of the at least one agent.

2. The system of claim 1, wherein the dynamic interface module is configured to group the plurality of agent cells into at least one group of agent cells based on one or more parameters of the at least one agents.

3. The system of claim 1, wherein the position of the plurality of agent cells is dynamic.

4. The system of claim 1, wherein the dynamic interface module is configured to arrange the position of the plurality of agent cells based on a performance of the agent.

5. The system of claim 1, wherein each agent cell comprises one or more characteristics to represent a status or attributes of the agent.

6. The system of claim 1, wherein the problem profile is selected in real time based on call data analysis including transcription of the call and keyword analysis.

7. The system of claim 1, wherein the problem profile is selected in real time based on call data analysis including audio signal analysis of the call and audio signal attribute analysis.

8. The system of claim 1, wherein the action profile is selected in real time based on the problem profile selection, call data analysis. and confidence score.

9. A method for providing a real time dynamic interface for supervising individuals, comprising the steps of:
providing at least one agent workstation, at least one supervisor workstation, and at least one server in communication with a database, the at least one agent workstation and the at least one supervisor workstation, wherein the server comprises a memory comprising a set of program modules and a processor configured to execute at least one program module, wherein each of the at least one agent workstation is operable by at least one agent, wherein each of the at least one supervisor workstation is operable by at least one supervisor;
monitoring, via an agent monitoring module at the server, a plurality of agent data of each agent, wherein the agent data includes call data, type of call, duration of call, availability of agent and actions used by the agent for a specific call, and client data;
analyzing, via a call data processing module at the server, a plurality of call data to generate a call data set, wherein the analysis involves analyzing audio data of the call data, transcribing the audio of the call data, analyzing keywords from the transcription, and transforming the call data into the call data set, wherein the call data set includes a plurality of features and attributes;
analyzing, via a problem detection module having a first machine learning model at the server, the call data set and generate a plurality of problem profiles;
analyzing, via an action profile module having a second machine learning model, the problem profiles to determine a plurality of actions for each problem profile;
generating a plurality of action profiles for each problem profile based on the analysis of the action profile module;
analyzing, via a strategy scoring module at the server, the problem profiles and the action profiles and generating a plurality of thresholds of the action profiles and the problem profiles;
selecting, by a problem profile manager at the server, upon the system receiving a new call, at least one problem profile;
selecting, by an action profile manager at the server, at least one action profile for the selected problem profile and analysis of the new call;
implementing, the plurality of actions in the selected action profile; and
displaying, via a dynamic interface module at the server, a real time dynamic interface based on analysis of the plurality of agent data, plurality of real-time call data, wherein the interface comprises a plurality of agent cells, wherein each agent cell represents the respective agent, wherein each cell includes one or more graphical attributes to represent at least one attribute of the agent.

10. The method of claim 9, further comprising the step of: enabling, via the dynamic interface module at the server, to group the plurality of agent cells into at least one group of agent cells based on one or more agent attributes comprising location of agents, experience, or client.

11. The method of claim 9, wherein the position of each of the plurality of agent cells is dynamic.

12. The method of claim 9, further comprising the step of: enabling, via the dynamic interface module at the server, to arrange the position of each agent cell of the plurality of agent cells based on a performance attribute of the agent.

13. The method of claim 9, wherein each agent cell of the plurality of agent cells comprises a status attribute of the agent.

14. The method of claim 9, wherein the problem profile is selected in real time based on based on call data analysis of the new call including transcription and keyword analysis.

15. The method of claim 9, wherein the problem profile is selected in real time based on based on call data analysis of the new call including audio signal analysis.

16. The method of claim 9, wherein the action profile is selected in real time based on call data analysis of the new call and confidence score.
